(19) United States
(12) Patent Application Publication
(10) Pub. No.: US 2009/0303265 A1
(43) Pub. Date: Dec. 10, 2009

(54) LCD DEVICE AND METHOD OF CONTROLLING THE SAME

(75) Inventor: Hideki KANOU, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/475,715

(22) Filed: Jun. 1, 2009

(30) Foreign Application Priority Data
Jun. 6, 2008 (JP) 2008-149028

(51) Int. Cl. G09G 3/36; G09G 5/10

(52) U.S. Cl. 345/690

(57) ABSTRACT

A liquid crystal display (LCD) device and an apparatus for controlling a liquid crystal display which can perform luminance adjustment no matter what illumination method is employed are provided. An image display screen is divided into a plurality of small regions, and a plurality of counter electrodes 26 are provided for the respective small regions such that the counter electrodes are arranged at positions opposing pixel electrodes with a liquid crystal layer therebetween. When the LCD displays an image, each dimming processor 36 obtains a brightness value of an image in an associated small region based on image data of the image to be displayed, obtains a common-line signal potential to be supplied to the associated counter electrode according to the obtained brightness value, and generates and supplies a correction signal according to the potential to a buffer circuit 40 associated with the counter electrode concerned. The buffer circuits 40 correct reference voltages supplied from a counter electrode drive inverter 38 according to the correction signals supplied from the dimming processors 36, and apply them as common-line signals to the respective counter electrodes 26.

### BACKGROUND OF THE INVENTION

1. Field of the Invention

The present invention relates to a liquid crystal display device that displays an image using liquid crystals and an apparatus for controlling the liquid crystal display.

2. Description of the Related Art

Enhancing the contrast is one solution if the image quality of a liquid crystal display (LCD) should be improved. A data processing technology for graphic engines and a so-called “dimming” method, which is a luminance adjustment method, are exemplary approaches to increase the contrast. In a known dimming method, an illumination region of an LED backlight for illuminating a liquid crystal panel is divided into a plurality of small regions and the luminance of the backlight is adjusted according to the brightness of an image to be displayed in each small region (for example, see Patent Reference 1).

The following is a more detailed description of the dimming method. First, image data in a graphic processor (or engine) is analyzed to extract brightness information (specifically, luminance data or gray levels of three primary colors which are derived from the original image data), and the extracted brightness information is stored in an image memory. Then, brightness information of each of the divided regions of a screen is retrieved from the image memory, and a current and a drive time (or pulse width) of an LED backlight driver that drives each of the divided regions is controlled based on the retrieved brightness information to adjust the intensity of illumination of the backlight.

[Patent Reference 1] Japanese Patent Application Kokai (Laid-Open) No. 2007-183608

### SUMMARY OF THE INVENTION

However, the above-described diming process cannot be applied to a method in which Cold Cathode Fluorescent Lamps (CCFLs) are used to illuminate the entire LCD screen as shown in FIG. 6 and to a method in which a light source mounted at an edge of the LCD is used to illuminate the entire screen through a light guide plate. To perform the above-described dimming process, it is necessary to use a lighting method which can directly illuminate the image display region (screen) and can also individually illuminate each of the divided regions of the image display region as when an LED backlight is employed. Light sources used in lighting systems for LCDs that are widely used mostly rely upon cathode fluorescent lamps such as CCFLs to emit light to the entire LCD screen and thus cannot employ the dimming method which divides the screen and controls the illumination range. In addition, the characteristics of CCFLs such as rising and falling times and the amount of time from a complete OFF (dark) state to an ON (bright) state vary depending on CCFLs and thus CCFLs are not suitable for the dimming process.

The LED backlight still needs to be improved in terms of lifetime, price, etc., and it is also very difficult to adopt the LED backlight, especially in an LCD TV having a large screen size. On the other hand, CCFLs are very widely used in LCD TVs and it will be ideal if the dimming process can be applied to such LCDs. Accordingly, there is a need to provide a dimming process which can be performed no matter which illumination method is employed.

The present invention has been made in view of the above circumstances, and it is an object of the present invention to provide a liquid crystal display device and an apparatus for controlling a liquid crystal display which can perform luminance adjustment no matter which illumination method is employed.

In order to accomplish the object of the present invention, a liquid crystal display device of the present invention includes a plurality of pixel electrodes which are arranged in a matrix in an image display region such that an AC voltage corresponding to image data is applied to the pixel electrodes, a plurality of counter electrodes which are provided respectively in association with a plurality of small regions (these small regions are defined by dividing the image display region) such that the counter electrodes are arranged at positions opposing the pixel electrodes respectively, with a liquid crystal layer being provided between each counter electrode and each pixel electrode, a calculation unit that obtains a plurality of values representing brightness of an image to be displayed in the small regions respectively on the basis of the image data, and a control unit that controls respective potentials of the counter electrodes according to the values obtained by the calculation unit.

An apparatus for controlling a liquid crystal display according to the present invention is used for a liquid crystal display that includes a plurality of pixel electrodes, which are arranged in a matrix in an image display region such that an AC voltage corresponding to image data is applied to the pixel electrodes, and a plurality of counter electrodes, which are provided respectively in association with a plurality of small regions (these small regions are defined by dividing the image display region) such that the counter electrodes are arranged at positions opposing the pixel electrodes respectively with a liquid crystal layer being provided between each counter electrode and each pixel electrode. The apparatus includes a calculation unit that obtains, when the liquid crystal display displays an image according to the image data, a plurality of values representing brightness of an image to be displayed in the small regions on the basis of the image data, and a control unit that controls respective potentials of the counter electrodes according to the values obtained by the calculation unit.

By providing the counter electrodes in the respective small regions of the image display region and adjusting the potential of each of the counter electrodes, as described above, it is possible to control the magnitude of a voltage applied to the liquid crystal layer between each pixel electrode and each counter electrode and thus to perform luminance adjustment regardless of the type of the illumination method employed.

Both the liquid crystal display device and the apparatus for controlling the liquid crystal display may further include a storage unit that stores values representing brightness and values representing potentials of the counter electrodes in a correlated manner and the control unit may read the values representing potentials stored in the storage unit respectively in association with the values representing brightness obtained by the calculation unit and may generate, for each of the counter electrodes, a voltage corresponding to a potential represented by a corresponding one of the read values and then may apply the generated voltage to the counter electrode concerned.

Thus, the present invention has an advantage that it is possible to adjust the luminance independently of the illumination method employed.

### DETAILED DESCRIPTION OF THE INVENTION

An embodiment of the present invention will now be described in detail with reference to the accompanying drawings.

FIG. 1 illustrates an exemplary equivalent circuit of a liquid crystal display device according to an embodiment of the present invention.

A Liquid Crystal Display (LCD) device according to this embodiment is an active-matrix LCD device, which uses Thin Film Transistors (TFTs) as switching elements, and includes a liquid crystal panel 10, a source driver 12, and a gate driver 16.

In the liquid crystal panel 10, a plurality of source lines 14 connected to the source driver 12 and a plurality of gate lines 18 connected to the gate driver 16 are arranged intersecting each other, and Thin Film Transistors (TFTS) 20 are connected at the intersections. Although TFTs are used as the switching elements in this embodiment, the present invention is not limited to the TFTs.

A storage capacitor 24 and a pixel electrode 28, which has about the same size as that of each pixel, are connected to a drain electrode of each TFT 20, and a counter electrode 26 is connected to one side of a liquid crystal layer 22 opposite to the pixel electrode 28. The counter electrode 26 includes a transparent conducting electrode such as an ITO electrode.

When an image is displayed on the liquid crystal panel 10, the gate driver 16 provides a gate signal to the gate lines 18 to make the potential of the gate lines 18 high. In synchronization with the provision of the gate signal, the source driver 12 provides a source signal, which corresponds to (represents) image data of the image to be displayed, to the source lines 14. A voltage corresponding to the difference between the source signal provided to the pixel electrode 28 through the TFT 20 and a common (common-line) signal provided to the counter electrode 26 is applied to the liquid crystal layer 22. The applied voltage drives the liquid crystal layer 22 to change the transmittance of light, which is incident on the liquid crystal layer 22 after being emitted from a backlight (not shown), thereby displaying the image.

The following is a description of a method for driving the liquid crystal layer 22. FIG. 2 is a graph illustrating VT characteristics of the liquid crystal layer 22, i.e., a relation between the transmittance of light through the liquid crystal layer 22 and a voltage applied to the liquid crystal layer 22 when the LCD is normally white (i.e., when the liquid crystal layer transmits light with no voltage applied to the liquid crystal layer). As shown in FIG. 2, the transmittance of light emitted from the backlight decreases as the applied voltage increases whereas the transmittance increases as the applied voltage decreases. It should be noted that the transmittance increases as the applied voltage increases whereas the transmittance decreases as the applied voltage decreases if the LCD is normally black (i.e., if the liquid crystal layer shields light with no voltage applied to the liquid crystal layer). In this manner, the luminance changes with the voltage applied to the liquid crystal layer 22.

Generally, the liquid crystal layer 22 is driven by AC (alternating current) in order to prevent burning of liquid crystal molecules. FIG. 3 illustrates waveforms of the voltage applied to a liquid crystal layer of a conventional LCD. The conventional counter electrode is integrally formed with the same size as that of the area of the liquid crystal panel. As shown in FIG. 3, a common signal having a specific potential is provided to the counter electrode and, assuming that this specific potential of the counter electrode is zero, a source signal, which alternates polarity between positive and negative polarities every specific time unit, is provided to the source line to perform AC driving. That is, the potential difference between the common signal having the specific (constant) potential and the source signal having positive or negative polarities is applied to the liquid crystal layer 22. In this example, the polarity is switched every frame (i.e., every picture of the image).

On the other hand, in this embodiment, the conventional integral counter electrode having a large area is replaced with a plurality of counter electrodes 26, each having a small(er) area, as shown in FIG. 4, and the potential (i.e., common-line potential) of a common signal applied to each of the counter electrodes 26 is controlled for each counter electrode 26 to perform a dimming process.

For example, when the LCD is normally white, transmittance can be increased to display a brighter image by decreasing the difference between the potential of the source signal and the potential of the common signal (i.e., by decreasing the voltage applied to the liquid crystal layer 22), whereas transmittance can be decreased to display a darker image by increasing the voltage applied to the liquid crystal layer 22 as described above. The level of the voltage applied to the liquid crystal layer 22 is adjusted by adjusting the common-line potential.

FIG. 4 illustrates a configuration of a drive device which drives the counter electrodes 26 in this embodiment. As shown in the drawing, a plurality of counter electrodes 26 are provided respectively in association with a plurality of small(er) regions (4 regions in FIG. 4). These small(er) regions are defined by dividing the display region of the liquid crystal panel 10. The common signals applied to the respective counter electrodes 26 are controlled independently of each other.

Although the number of the counter electrodes 26 and the area of each counter electrode are not limited to specific ones, it is preferable that each counter electrode 26 be formed with a size required for the dimming process. For example, the number and area of the counter electrodes 26 may be determined according to a required LCD quality.

The drive device for driving the counter electrodes 26 includes an RGB converter 30, an image memory 32, a data extractor 34, a plurality of dimming processors 36 provided in association with the respective counter electrodes 26, a counter electrode drive inverter 38, a plurality of buffer circuits 40 provided in association with the respective counter electrodes 26, and a Look-Up Table (LUT) 42. The counter electrodes 26 are connected to the buffer circuits 40 through a plurality of common lines 44, respectively.

The RGB converter 30 converts image data of YUV corresponding to one frame, where Y, U, and V is data representing luminance (Y), blue (U), and red (V), into image data of RGB, where R, G, and B is grayscale data representing gray levels of Red (R), Green (G), and Blue (B), and then writes the RGB image data in the image memory 32.

The data extractor 34 reads R, G, and B grayscale data from the image memory 32 and divides the data into a plurality of small-region data corresponding to the respective counter electrodes 26. The data extractor 34 then introduces the small-region data into the associated dimming processors 36.

When each of the dimming processors 36 receives grayscale data of a corresponding small region from the data extractor 34, the dimming processor 36 calculates a value representing luminance based on the grayscale data. For example, the value representing luminance calculated by each dimming processor 36 may be an average of all grayscale data that the dimming processor 36 has received or it may be a value that the dimming processor 36 has calculated using a certain algorithm.

In addition, each of the dimming processors 36 obtains the potential of a common signal supplied to a corresponding counter electrode 26 based on both the calculated luminance value and the LUT 42.

The LUT 42 is a lookup table that stores values representing luminance and values representing common-line potentials Vcom applied to the counter electrodes 26 in a table format. This lookup table has been prepared according to the VT characteristics of the liquid crystal layer 22, required display characteristics (for example, a required level of apparent contrast), or the like. The LUT 42 may be stored in a rewritable nonvolatile memory such as an EEPROM, or may be stored in a non-rewritable memory or a volatile memory. If the LUT 42 is provided in the form of a volatile memory, there is a need to employ a mechanism for writing the data of the LUT 42 to the memory at a predetermined time, for example when the LCD device starts up. If the display characteristics are changed according to a user request, the content of the LUT 42 should also be changed correspondingly. Therefore, in this case, it is preferable to use a rewritable memory.

Each of the dimming processors 36 reads a value of a common-line potential Vcom, which is stored in association with the luminance value concerned, from the LUT 42 and generates and supplies a correction signal according to the value of the common-line potential Vcom to the associated buffer circuit 40. The generated correction signal is used to correct the potential of the reference voltage supplied from the counter electrode drive inverter 38, which is described later, to a common-line potential Vcom represented by the value read from the LUT 42. For example, the generated correction signal may be a signal representing the common-line potential Vcom or may be a signal representing the potential difference between the common-line potential Vcom and the potential of the reference voltage output from the counter electrode drive inverter 38. The potential difference will now be referred to as a “correction voltage Δv”.

Accordingly, for example when there is a need to increase the apparent contrast, each dimming processor generates and outputs a correction signal (for increasing the transmittance of the liquid crystal layer 22) for a bright region (in which the value representing luminance indicates brightness higher than a predetermined value) so as to make the region brighter, and generates and outputs a correction signal (for decreasing the transmittance of the liquid crystal layer 22) for a dark region (in which the value representing luminance indicates brightness lower than the predetermined value) so as to make the region darker.

Although the LUT 42 is a lookup table that stores and correlates values representing luminance and values representing common-line potentials Vcom applied to the counter electrodes 26 in this embodiment, the LUT 42 may be another type of lookup table that stores and correlates the values representing luminance and values representing correction voltages Δv and each dimming processor 36 may read a correction voltage Δv, which is stored in association with the value representing luminance, from the LUT 42 and then may generate and output a correction signal based on the correction voltage Δv.

Each of the buffer circuits 40 receives a specific DC current (reference voltage) from the counter electrode drive inverter 38. As shown in FIG. 5, each of the buffer circuits 40 adjusts impedance according to a correction signal received from a corresponding dimming processor 36 to correct the potential of the reference voltage and applies the corrected reference voltage as a common-line signal to the corresponding counter electrode 26.

The above-described procedure is repeated every frame or every two (or more) frames.

Since a common-line potential for each of the counter electrodes 26 is adjusted according to the brightness of an image for that counter electrode 26 to change an effective voltage applied to the liquid crystal layer 22 as described above, it is possible to perform the dimming process (luminance adjustment) no matter what illumination method is employed.

That is, it is possible to perform the dimming process not only for an LCD which employs an illumination method using lamps such as CCFLs but also for a reflective-type LCD which uses no backlight. The method of the present invention is also effective for a system which illuminates the entire screen through a light guide plate with one or two lamps such as CCFLs being mounted at an edge(s) of a liquid crystal display portion as in a notebook or laptop computer. The method can also be applied to an LCD which uses an LED backlight.

The present invention is not limited to the above-described embodiment and various design modifications can be made without departing from the scope of the invention defined by the claims.

For example, although the illustrated embodiment is directed to a case where YUV image data is converted into RGB image data and a value representing brightness is obtained from the RGB image data to perform the dimming process, the present invention is not limited in this regard. For instance, the value representing brightness may be obtained from a luminance value representing YUV image data before the image data is converted into RGB image data. In this case, each dimming processor may receive luminance values of a corresponding region and then may calculate an average of the received luminance values and use it as the value representing brightness, as in the above-described embodiment. Alternatively, the dimming processor may calculate a value, which is obtained from a received luminance value(s) using an independent algorithm, and use the resulting value as the value representing brightness.

In addition, although the above-described embodiment has been described with reference to an active-matrix LCD such as a TFT LCD, the present invention is not limited in this regard. The present invention can also be applied to other types of LCDs including passive-matrix LCDs such as STN or DSTN.

### BRIEF DESCRIPTION OF THE DRAWINGS

FIG. 1 illustrates an exemplary equivalent circuit of a liquid crystal display device according to one embodiment of the present invention;

FIG. 2 is a graph illustrating VT characteristics of a liquid crystal layer, i.e., a relation between transmittance and voltage applied to the liquid crystal layer;

FIG. 3 illustrates how a conventional liquid crystal panel is driven by AC;

FIG. 4 illustrates a configuration of a drive device which drives counter electrodes according to the embodiment;

FIG. 5 illustrates how a liquid crystal panel is driven by AC in the embodiment; and

FIG. 6 schematically illustrates an LCD in which a liquid crystal panel is illuminated using Cold Cathode Fluorescent Lamps (CCFLs).

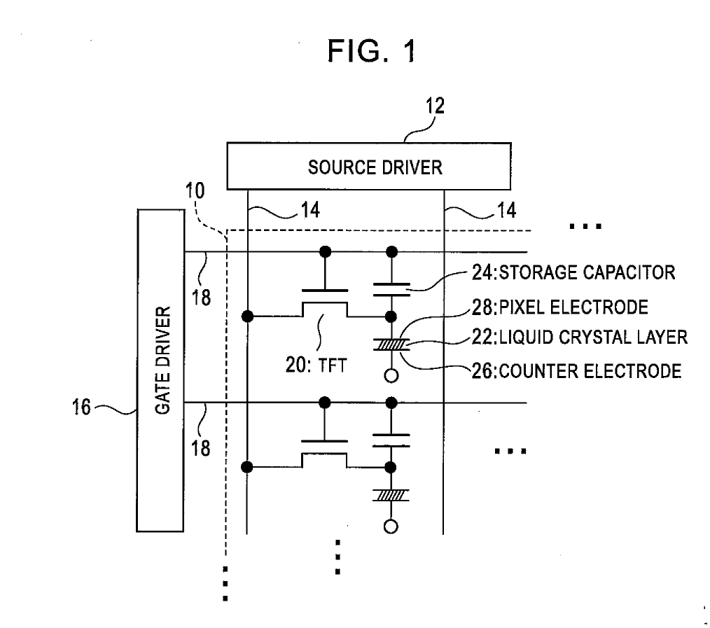

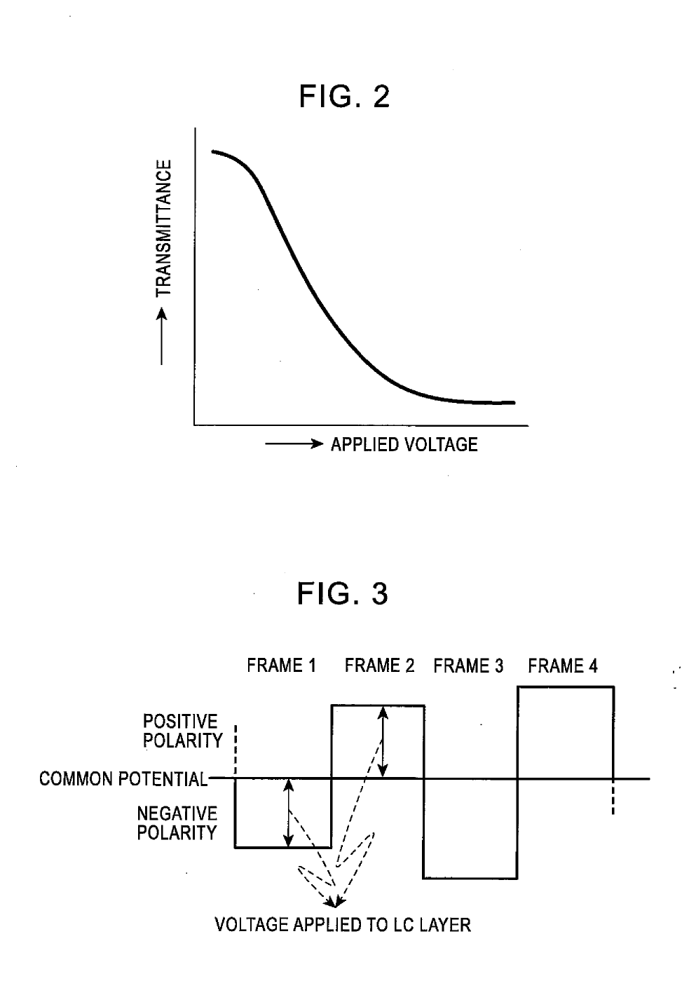

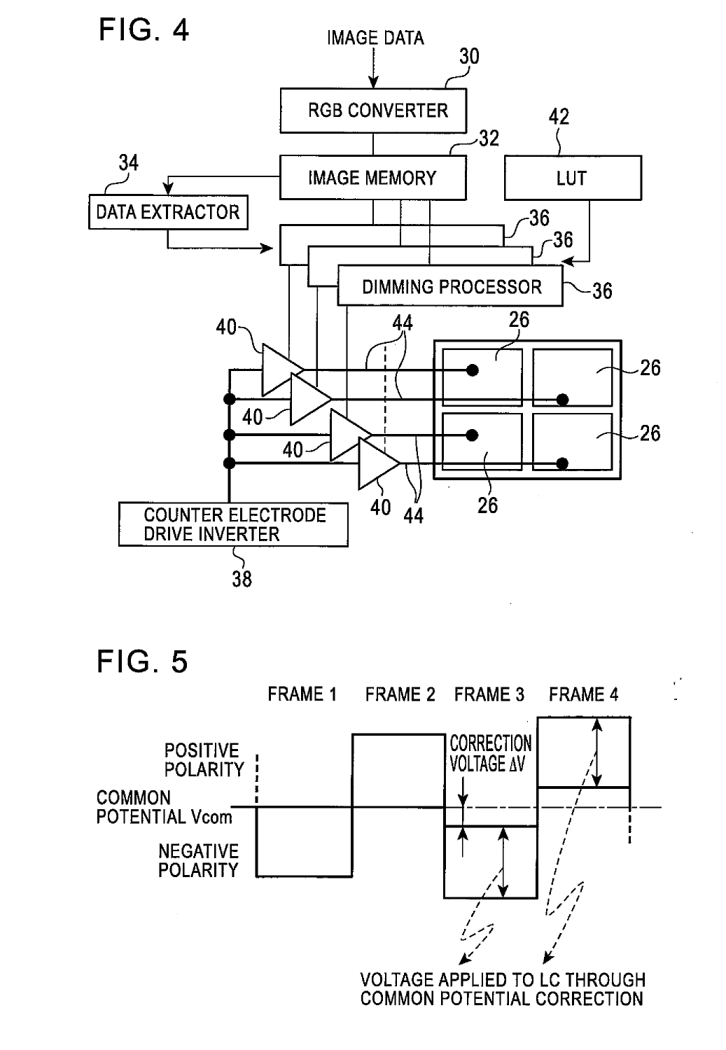

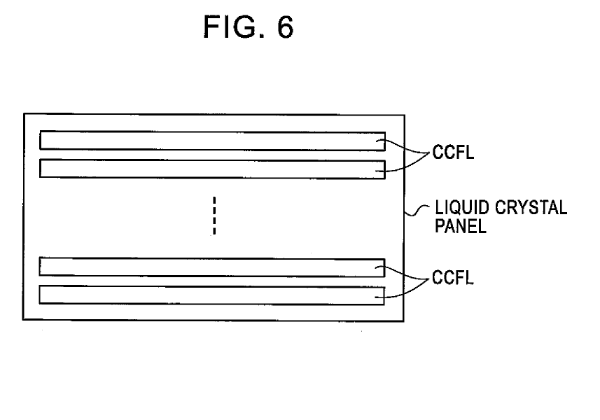

### SYMBOLS

10 LCD Panel
12 Source Driver
14 Source Line
16 Gate Driver
18 Gate Line
20 Heisei
22 Liquid Crystal
24 Accumulated Capacitance
26 Counter Electrode
30 Converter
32 Image Memory
34 Data Extractor
36 Dimming processor
38 Counter Electrode Drive Inverter
40 Buffer Circuit
42 LUT
44 Common Line

This application is based on Japanese Patent Application No. 2008-149028 filed on Jun. 6, 2008, the entire contents of which are incorporated herein by reference.

What is claimed is:

1. A liquid crystal display device comprising:
a plurality of pixel electrodes which are arranged in a matrix in an image display region and to which an AC voltage corresponding to image data is applied;
a plurality of counter electrodes which are provided respectively in association with a plurality of small regions, the plurality of small regions being defined by dividing the image display region, such that the counter electrodes are arranged at positions opposing the plurality of pixel electrodes respectively, with a liquid crystal layer being provided between each said counter electrode and each said pixel electrode;
calculation means that obtains a plurality of values representing brightness of an image to be displayed in the plurality of small regions respectively, based on the image data; and
control means that controls respective potentials of the plurality of counter electrodes according to the values obtained by the calculation means.

2. The liquid crystal display device according to claim 1, further comprising storage means that stores values representing brightness and values representing potentials of the counter electrodes in a correlated manner,
wherein the control means reads the values representing potentials from the storage means in association with the values representing brightness obtained by the calculation means, generates, for each of the counter electrodes, a voltage corresponding to a potential represented by a corresponding one of the read values, and applies the generated voltage to each said counter electrode concerned.

3. An apparatus for controlling a liquid crystal display including a plurality of pixel electrodes, which are arranged in a matrix in an image display region and to which an AC voltage corresponding to image data is applied, and a plurality of counter electrodes, which are provided respectively in association with a plurality of small regions, the plurality of small regions being defined by dividing the image display region, and which are arranged at positions opposing the plurality of pixel electrodes respectively with a liquid crystal layer being provided between each said counter electrode and each said pixel electrode, the apparatus comprising:
calculation means that obtains, when the liquid crystal display displays an image according to the image data, a plurality of values representing brightness of an image to be displayed in the plurality of small regions respectively based on the image data; and
a control unit that controls respective potentials of the plurality of counter electrodes according to the values obtained by the calculation means.

4. The apparatus according to claim 3, further comprising storage means that stores values representing brightness and values representing potentials of the counter electrodes in a correlated manner,
wherein the control means reads the values representing potentials from the storage means in association with the values representing brightness obtained by the calculation means, generates, for each of the counter electrodes, a voltage corresponding to a potential represented by a corresponding one of the read values, and applies the generated voltage to each said counter electrode concerned.
